(19) United States
(12) Patent Application Publication
(10) Pub. No.: US 2006/0240217 A1
(43) Pub. Date: Oct. 26, 2006

(54) Fire-retardant, lightweight aircraft carpet

(75) Inventors: Stephen W. Foss, Rye Beach, NH (US); Charies deErney, LaCroix sur Lutry (CH)

Correspondence Address: BURNS & LEVINSON, LLP;(FORMERLY PERKINS SMITH & COHEN LLP), 125 SUMMER STREET, BOSTON, MA, 02110, US

(73) Assignee: Foss Manufacturing Co., Inc., Hampton, NH (US)

(21) Appl. No.: 11/111,515

(22) Filed: Apr. 21, 2005

(51) Int. Cl. B32B 33/00; B32B 3/02

(52) U.S. Cl. 428/97; 428/95; 428/920

(57) ABSTRACT

The present invention is a lightweight carpet for use in aircrafts that meets rigorous fire standards testing, is impervious to fluids, and is capable of being printed for decorative effect. In one embodiment, the carpet composed of a layer of fire retardant treated PET fibers adhered to a fire retardant treated PE film. This carpet is durable to normal foot traffic, resistant to most stains, non-fraying, and can be recycled.

### FIELD OF THE INVENTION

The present invention relates to flame-retardant, moisture impermeable materials, and more particularly to lightweight materials for use in textiles, such as used in carpeting.

### BACKGROUND OF THE INVENTION

Carpeting employed in mass transit vehicles such as, for example, aircraft, traditionally consists of tufted carpets, composed of a blend of nylon and wool. The current properties of aircraft carpeting include good durability of nylon and the charring ability of wool during a fire. Fire safety standards are promulgated by governmental regulatory agencies such as the Federal Aviation Agency, which additionally monitor compliance thereto. The airline industry itself also maintains fire safety standards, as well as standards for smoke emissions and toxic gases caused during fires. These regulations are continually changing to meet more stringent safety requirements.

Both nylon and wool are relatively easy to dye, but are easily stained. In tufted carpet, yarn, typically consisting of nylon, polyester, wool or polypropylene, is stitched into a primary backing that is woven from a polypropylene slit film or a spunbonded nonwoven. Tufted airline carpets typically also include a porous latex coating on the back surface of the backing to increase resistance to abrasion. The porosity of the coating can lead to corrosion of the airframe as liquids, such as wine, water, or coffee, seep through the carpet. Pooled liquid below the carpet surface or pile may give rise to mold, mildew, and bacterial growth, causing the pad to emit an unpleasant odor. Since adequate cleaning of carpeting requires the use of strong chemicals such as, for example, chlorine bleach, that also remove the color from the carpet, carpets are often replaced primarily due to stains. The latex is additionally undesirable from a recycling point of view as well as smoke and fumes. In order to reclaim the carpet fibers and scrim, which are normally polypropylene, polyester, or polyamide based, the latex would have to be separated from the total composite. However, since most aircraft carpet is a blend of nylon and wool, it is not readily recyclable.

In an effort to reduce costs, carriers are constantly seeking ways to reduce the weight of their aircraft in order to save on fuel and oil expenses. Tufted carpets are typically heavy, weighing about 56 oz per square yard or 1,900 grams per square meter (gsm.) The cost, for example, for an airline carrier is estimated to be $100 (USD)/kg per year to fly unnecessary excess weight.

Thus, there currently exists a need for materials that impart the properties of flame resistance and fluid impermeability to products such as carpeting, while being lightweight, recyclable, and abrasion resistant.

### SUMMARY OF THE INVENTION

It is one object of the present invention to provide a lightweight carpet material for high performance usage, usable, for example, in aircraft and withstanding rigorous fire standards, being impervious to fluids, and capable of being printed for decorative effect.

It is another object that the carpet material be durable to normal foot traffic and is resistant to most stains. The finished carpet product is non-fraying, eliminating the need for expensive serging on the edges.

In yet another object that the carpet material be easily recycled into resin-based fibers, using trim and other waste of carpet manufacture and carpets at the end of their serviceable lives.

The carpet may be printed in any design (customized for each airline) using either pigments (inks) or dyes (sublistatic).

The foregoing and other objects are achieved by a carpet material (and a method of preparation thereof) and resultant carpet having a non-woven, face fabric layer formed of synthetic fire/flame retardant (FR) fibers including a proportion of fire retardant additives that allows the carpet to meet FAA, European and ASTM airline carpet flammability regulations and standards (collectively, “standards”.) An extruded plastic barrier layer substantially impermeable to fluids may be adhered to the face layer. In certain embodiments, an additional lightweight, backing layer composed of synthetic FR fibers forms laminate structures with the face layer and barrier layer to enhance durability, acoustics, comfort, and thermal insulation. In any of the carpet embodiments described below, a porous adhesive web may also be laminated to the carpet so as to improve acoustics (i.e., to reduce sound reflections from or transmission through the carpet.)

In another embodiment, the face layer and backing layer can be laminated using a porous adhesive web to improve air porosity, achieve additional acoustic properties, and achieve even lighter weight. The adhesive web weighs between 10 and 200 gsm, and can alternatively be applied to the floor-facing surface of the face layer in carpet embodiments without a backing layer, and the floor-facing surface of the backing layer in carpets with both face and backing layers.

In one embodiment, the fibers of the non-woven face layer are formed of a thermoplastic resin such as, for example, PET (polyethylene terephthalate), treated with phosphorus polymerized with ethylene glycol and terephthalic acid. This composition provides a number of desirable properties, including excellent abrasion and stain resistance, the ability to be pigmented, printed, or dyed, resistance to fraying as a result of cutting, recyclability, and, of course, flame retardance. The extruded barrier layer is preferably composed of PET and an effective amount of FR additive(s) such as phosphorous and commercially available additives such as, for example, CIBA EXOLIT™ and/or TECHMER™ PBM12635. The barrier polymer could also be composed of PP, PE, EVA, PVC, polyamide {nylon 6, 6,6, 6,12, etc.}, acrylic, modacrylic, polytrimethylene terephthalate (PTT), PCT, or co-polyester, and mixtures thereof, with or without FR additives (the lack of additives in the barrier layer may be compensated for with a greater amount of FR additives in the face layer.) One cost effective carpet that utilizes FR PE fibers in the face layer and FR PET in the barrier layer is recyclable, as a small amount of PE may be compatible with PET.

### BRIEF DESCRIPTION OF THE FIGURES

For a better understanding of the present invention, together with other and further objects thereof, reference is made to the accompanying drawing and detailed description, wherein:

FIG. 1 is a cross-sectional view of a FR carpet having a non-woven face layer adjacent optional barrier, backing layers and an optional porous adhesive web.

### DETAILED DESCRIPTION OF PREFERRED EMBODIMENTS OF THE INVENTION

The present invention relates to one or more layers of FR materials used as a lightweight carpet that withstands rigorous testing to fire standards and/or regulations such as, for example, ASTM flammability standards and similar regulations for flammability, smoke and toxicity promulgated by the U.S. Federal Aviation Administration (FAA) and European governments and airlines.

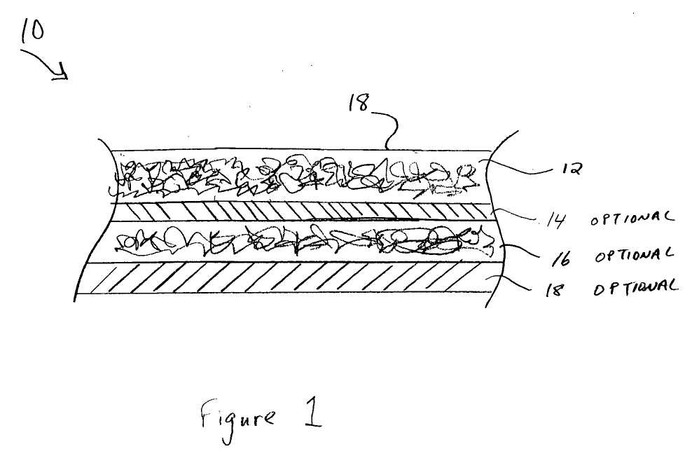

With reference to FIG. 1, a lightweight FR carpet 10 may be comprised of a face layer 12 of nonwoven fabric and, optionally but preferably, an extruded thermoplastic barrier layer 14 and a woven or nonwoven polymeric backing layer 16. The face layer can be formed in any length or width, and typically has a thickness between about 0.10 and 0.75 inches (0.04 to 0.25 mm) and preferably between about 0.18 and 0.31 inches. The extruded barrier layer typically has a thickness of about 0.001 to 0.040 inches, and the backing layer has a thickness from about 0.05 to 1.00 inches.

The fabric of the face layer 12 is manufactured from synthetic FR fibers including FR additives in a proportion allowing the carpet to meet the desired flammability standards. The term “fibers”, as used herein, means individual staple fibers or continuous filaments. To obtain the desired fire resistance properties in the fibers, FR additives are co-extruded with the selected polymer resin in an amount from about 0.1% to 10% by weight of the fiber at a temperature above the melting point of the mixture. Examples of synthetic polymers for use in the FR fibers include polyethylene terephthalate (PET), polycyclohexylenedimethylene terephthalate (PCT), polypropylene (PP), polyethylene (PE), polyamide (PA) (6; 6,6; 6,12; etc.), PTT, co-polyester, and modacrylic, and mixtures thereof, and may range from about 0.25 inches in length to continuous filaments.

The fabric of the face layer 12 may be formed from the FR fibers through traditional non-woven fabric entangling production techniques such as, for example, needle punching, spin bonding, spin lacing, stitch bonding, weaving, knitting or carded webbing, so as to provide a textured ‘feel’ at a first surface 18 exposed to foot traffic. The face layer 12 weighs between about 80 and 1000 gsm, and more preferably from about 200 and 500 gsm. The FR fibers (of either the face fabric layer 12 or backing layer 16) may be pigmented or solution dyed during manufacture, and may be coated by or coextruded with anti-microbial and/or anti-fungal inorganic additives (e.g., silver, copper, zeolites thereof, etc.) The fabric of face layer 12 may also be printed with ink or subslistatic dyes in, for example, patterns that simulate a tufted carpet appearance.

In one preferred embodiment, the face layer is produced from a FR PET fiber by feeding the fiber through a series of opening feeders the to separate extruded bundles of fibers into individual fibers to provide a more uniform web. The fibers are then passed through a metering feeder to control the flow rate into a card and to control the finished fabric weight. The fibers are then fed into a carding machine (a machine that has opposing rolls that are covered with saw tooth wire). The card “combs” the fibers into a uniform web of approximately 60″ to 120″ wide. The web is then cross-lapped with multiple layers to provide a uniform fabric web and to balance machine and cross-machine properties such as tensile and elongation. The fabric is then undergoes a series of needle-punching (through standard automated machinery), first on a top surface of the fabric, then on the bottom, and finally on the top again. Needles in the range of 28 to 46 wire gauge may be used. The fabric is then trimmed to desired width (ranging from 18″ to 160″) and wound up in rolls.

As noted, the fibers of the face layer 12 may be pigmented to a mottled gray, for example, to provide a better background for subsequent printing, and/or the face layer fabric may be passed trough a dye bath and dried to provide a gray background. The color may vary based on the subsequent design and colors in the printing process.

The backing layer 16 is similarly produced from either FR or non-FR fibers. The process is preferably the same as for producing the face layer fabric, but could alternatively involve stitch-bonding, spun lacing, spun bonding, or dry carding processes.

In preferred embodiments, the face and backing fabrics are bonded by any of a variety of processes. In one example, the face layer 12 and backing layer 16 undergo a lamination process, which is accomplished with extrusion of a plastic film 14 that serves as a substantially fluid-impermeable barrier layer for the carpet. As noted above, however, both the backing layer 16 and the extruded film/barrier layer 14 are optional. The extruder may be of a standard design and typically is in the size range of 2″ to 6″ in diameter. A FR carpet produced by this process employed a 4.5″ extruder with a 30:1 length/diameter ratio. An extrudate of polyethylene with a FR additive was pushed through an 80″ wide film die by a metering pump to control the output rate of the molten polymer. A film of 0.005 inches (a suitable thickness range being, for example, about 0.003 to about 0.015″) in thickness and weighing approximately 3 ounces per square yard was formed, which is within a suitable film weight range of about 25 and 1000 grams per square meter. The face layer 12 and backing layer 16 are then adhered to the molten barrier film layer 14. In the experiments conducted, the face and backing fabrics and a molten polyethylene were pressed between two 16″ long nip rolls with a preset gap of 0.150″ and then wrapped around chilling rolls to cool and solidify the polyethylene. Temperature and/or pressure conditions effective with a film applied polymer layer can be determined by one of ordinary skill in the art. The finished fabric was then trimmed to about 60 inches (˜1.5 meters.)

In another FR carpet actually produced, face and backing fabrics were laminated by placing a polyamide web between the fabrics and then heating the laminate by passing it over a hot oil heated drum (150° C.) under a Nomex blanket for pressure. The laminated fabrics were then cooled and trimmed to about 60 inches.

In another example, an adhesive film was used. The film had an adhesive layer, a barrier layer, and an adhesive layer. The film was heated so that the adhesive layers became sticky and the face and backing layers we laminated through pressure rollers.

In yet another example, a porous adhesive web 20 was heated and laminated between the face layer 12 and backing layer 16 with pressure rollers. The result was a porous composite that achieved better acoustic and/or thermal properties, while not having the fluid barrier effect. (Note that FIG. 1 illustrates the adhesive web 20 as adhered to the floor-facing surface of the backing layer 16, which is an alternative configuration, as opposed to being positioned between the face layer 12 and backing layer 16; in the laminate configuration not shown, web 20 would supplant the barrier layer 14 shown in the figure.)

Several of the carpets manufactured by the applicants were subjected to a printing process, wherein the face fabric was printed with an ink jet printer using sublistatic dyes. A pattern was chosen to give the appearance of a tufted carpet. In another instance, an ink jet printer using pigments was used, wherein it was determined that pigments could not be driven as deeply into the fabric, tending to remain closer to the surface 18 of the face layer. While the pigment printing obtained was adequate, the pigments' abrasion resistance was not as high as that of the sublistatic dyes. In a third instance, the face was printed using conventional roller printing with excellent results. In a fourth instance, the face was printed using transfer print paper using sublistatic dyes.

Finally, the finished aircraft carpet was cut into rolls approximately 3 feet wide. It was found that the carpet did not need to be hemmed or bound because it does not fray or unravel as normal carpeting does.

The selected synthetic polymers and FR additives are preferably melt-processed into FR fibers by procedures such as extrusion or polymerization (direct linked, either continuous or batch process) known to persons skilled in the art. Various fibers have been formed from 1.5 to 15 deniers (though 0.5 to 50 deniers would have also been suitable) from commercially available Fossfiber® FRF fibers, composed of IINVISTA™ PET resin 8934H and phosphorous polymerized with ethylene glycol and terephthalic acid, though other FR additives could be employed, such as CIBA EXOLIT™ OP950 and TECHMERT™ PBM12635. New FR additives are presently being developed to meet the needs of FR fibers and can be utilized in a manner consistent with the processes describe herein, depending upon their FR efficacy. The FR additives should range from 0.1% to 10% based on fiber weight, with the typical range from 0.5% to 5%. In a non-limiting example, a face fabric was formed at approximately 400 gsm (˜1.8 oz.) from both natural and pigmented FR fibers at 6.0 denier×76 mm.

The fabric of the face layer 12 may also be formed of blends of the FR fibers and about 0.5% to 7% binder fibers composed of, for example, PETG, PE, PP and/or Co-PET to increase the abrasion resistance of the face fabric layer. Blended PETG binder fibers have been found to be a preferable blend material.

The FR additives may be present in a sufficient amount to permit the barrier layer 14 to meet the flammability test standards and/or regulations, or the respective concentrations of FR additives in the face layer 12 and barrier layer 14 may be adjusted to allow the concentration to be lower in one layer than the other, while still permitting the carpet 10 as a whole to meet the flammability requirements.

The barrier layer 14 preferably weighs from about 25 to 1000 gsm. In a non-limiting example, the barrier layer 14 was formed to weigh approximately 80 gsm. The barrier layer 14 provides a barrier impermeable to fluids such as coffee and sodas spilled on the carpet. By “impermeable”, it is meant that the barrier can withstand normal foot traffic and cleaning without allowing spilled fluids to traverse the primary backing layer to the region below the carpet through tears in the layer or through seepage.

Additional cushioning may be provided to the carpet 10 by the backing layer 16, which as noted above comprises a fibrous (woven or nonwoven) fabric formed of synthetic FR fibers. In a non-limiting example, a carpet was made having a backing fabric layer weighing approximately 300 gsm, although weights from about 10 to 1000 gsm (and preferably about 50 to 500 gsm) would be acceptable and desirable for improved cushioning, acoustics, and thermal barrier.

In another non-limiting example, a carpet in accordance with the present invention may be formed wherein the FR fibers of the face fabric layer are composed of PET and PETG, the primary backing layer is composed of PE, and the FR fibers of the secondary backing layer are composed of PET, thereby permitting all the layers of the carpet to be recycled into PET fibers.

Although the invention has been described in conjunction with preferred and alternate embodiments thereof, it is evident that many alternatives, modifications, and variations of the invention will be apparent to those skilled in the art in light of the foregoing description. Accordingly, it is intended to embrace within the invention all such alternatives, modifications, and variations that fall within the spirit and scope of the appended claims.

It is claimed:

1. A lightweight, fire resistant carpet, comprising a non-woven face layer comprised of synthetic fibers modified with a fire resistant additive composed of phosphorous polymerized with ethylene glycol and terephthalic acid such that the face fabric meets airline carpet flammability standards, the synthetic fibers being formed at least in part of a polymer selected from the group consisting of polyethylene terephthalate (PET), polycyclohexylenedimethylene terephthalate (PCT), polypropylene (PP), polyethylene (PE), polyamide (PA) (6, 6,6, 6,12), polytrimethylene terephthalate (PTT), co-polyester, and modacrylic.

2. The carpet of claim 1, further comprising an extruded barrier layer adjacent the face layer and including therein fire retardant additives in a proportion allowing the carpet to meet airline carpet flammability standards, the extruded barrier layer being formed at least in part of a polymer selected from the group consisting of PP, PE, EVA, PVC, PET, or PA.

3. The carpet of claim 2, further comprising a fibrous backing layer adjacent the barrier layer comprised of synthetic fibers modified with a fire resistant additive composed of phosphorous polymerized with ethylene glycol and terephthalic acid such that the face fabric meets airline carpet flammability standards, the synthetic fibers being formed at least in part of a polymer selected from the group consisting of PET, PCT, PP, PE, PA (6, 6,6, 6,12).

4. The carpet of claim 1, wherein the face layer weighs between about 80 and 1000 grams per square meter.

5. The carpet of claim 1, wherein the face layer weighs between about 100 and 500 grams per square meter.

6. The carpet of claim 1, wherein the fibers of the face layer is printed with pigments or sublistatic dyes.

7. The carpet of claims 1-3, further comprising a porous adhesive web laminated to the carpet so as to reduce acoustics from or through the carpet.

8. The carpet of claim 7, where in the adhesive web weighs between about 10 and 200 grams per square meter.

9. The carpet of claim 1, wherein the FR additives are present in an amount from about 0.1% to 10% based on fiber weight.

10. The carpet of claim 1, wherein the FR additives are present in an amount from about 0.5% to 5%.

11. The carpet of claim 1, wherein the face layer further comprises a blend of abrasion resistance enhancing binder fibers composed of at least one material selected from the group consisting of PETG, PE, PP, and Co-PET.

12. The carpet of claim 11, wherein the binder fibers are PETG and are present in an amount of about 0.5% to 7% by weight of the carpet.

13. The carpet of claim 1, wherein the fibers of the face layer range from about 0.5 to 50 denier.

14. The carpet of claim 1, wherein the fibers of the face layer range from about 1.5 to 15 denier.

15. The carpet of claim 1, wherein the fibers of the face layer range from about 0.25 inches in length to continuous filaments.

16. The carpet of claim 1, wherein the fibers of the face layer include anti-microbial/anti-fungal inorganic additives.

17. The carpet of claim 2, wherein the extruded barrier layer is substantially impermeable to fluids.

18. The carpet of claim 2, wherein the polymer comprising the barrier layer is PP.

19. The carpet of claim 2, wherein the barrier layer weighs between about 25 and 1000 grams per square meter.

20. The carpet of claim 3, wherein the backing layer weighs between about 10 and 1000 grams per square meter.

21. The carpet of claim 3, wherein the backing layer weighs between about 50 and 500 grams per square meter.

22. The carpet of claim 3, wherein the fibers of the backing layer range from about 0.5 to 50 denier.

21. The carpet of claim 3, wherein the fibers of the backing layer range from about 0.25 inches in length to continuous filaments.

22. The carpet of claim 3, wherein the fibers of the backing layer include anti-microbial/anti-fungal inorganic additives.

23. The carpet of claim 3, wherein the fibers of the face layer are composed of PET and PETG, the extruded barrier layer is composed of PE, and the fibers of the backing layer are composed of PET, thereby permitting the layers to be recycled into PET fibers.

24. A method of preparing a lightweight, flame-resistant carpet, comprising the steps of:
co-extruding a synthetic polymer with phosphorous polymerized with ethylene glycol and terephthalic acid so as to form fire resistant fibers that meet airline carpet flammability standards; and
forming a non-woven face layer from the fire resistant fibers of sufficient thickness to be durable to foot traffic.

25. The method of claim 24, further comprising the step of:
co-extruding a barrier layer adjacent the face layer from a polymer selected from the group consisting of PP, PE, EVA, PVC, PET, or PA and fire retardant additives in a proportion allowing the carpet to meet airline carpet flammability standards and be substantially impermeable to fluids.

26. The method of claim 24, further comprising the steps of:
co-extruding a synthetic polymer with phosphorous polymerized with ethylene glycol and terephthalic acid so as to form fire resistant fibers that meet airline carpet flammability standards;
forming a fibrous backing layer from the fire resistant fibers of sufficient thickness to be durable to foot traffic; and
bonding a barrier layer between the face layer and the backing layer from a polymer selected from the group consisting of PET, PCT, PP, PE, PA (6, 6,6, 6,12) and fire retardant additives in a proportion allowing the carpet to meet airline carpet flammability standards.

27. The method of claim 24, further comprising the steps of:
co-extruding a synthetic polymer with phosphorous polymerized with ethylene glycol and terephthalic acid so as to form fire resistant fibers that meet airline carpet flammability standards;
forming a fibrous backing layer from the fire resistant fibers of sufficient thickness to be durable to foot traffic; and
laminating a porous adhesive web between the face layer and the backing layer so as to reduce acoustics from or through the carpet.

28. The method of claim 24, further comprising the step of:
printing the face layer with pigments or sublistatic dyes.

29. The method of claim 24, wherein the face layer forming step further comprises the step of:
blending the fire resistant fibers with abrasion resistance enhancing binder fibers composed of at least one material selected from the group consisting of PETG, PE, PP, and Co-PET.

30. The method of claim 24, wherein the co-extruding step further comprises the step of:
mixing, prior to co-extrusion, anti-microbial additives with the resin and the phosphorous.
